(19) United States
(12) Patent Application Publication
(10) Pub. No.: US 2014/0013272 A1
(43) Pub. Date: Jan. 9, 2014

(54) Page Editing

(71) Applicant: NAVICO HOLDING AS, Egersund (NO)

(72) Inventors: Stephen Thomas, Tulsa, OK (US); Paul Butterworth, Auckland (NZ)

(21) Appl. No.: 13/866,552

(22) Filed: Apr. 19, 2013

Related U.S. Application Data
(60) Provisional application No. 61/668,962, filed on Jul. 6, 2012.
(60) Provisional application No. 61/708,561, filed on Oct. 1, 2012.
(60) Provisional application No. 61/801,024, filed on Mar. 15, 2013.

(51) Int. Cl. G06F 3/0484

(52) U.S. Cl. CPC G06F 3/04842
USPC 715/800; 715/781

(57) ABSTRACT

Described herein are various implementations for an apparatus and method for displaying marine electronics data. In one implementation, a non-transitory computer-readable medium has stored thereon computer-executable instructions. When the computer-executable instructions are executed by a computer, the computer-executable instructions cause the computer to present a plurality of possible marine electronics data types to be displayed. The computer-executable instructions also cause the computer to receive two or more selections of the possible plurality of marine electronics data types and provide a plurality of templates for displaying the two or more selections. Each template includes two or more windows corresponding to the two or more selections. The computer-executable instructions are further configured to cause the computer to receive a selection from the plurality of templates and display the two or more selections of the plurality of marine electronics data types in the two or more windows.

### CROSS-REFERENCE TO RELATED APPLICATIONS

This application claims the benefit of U.S. Provisional Patent Application Ser. No. 61/801,024, filed Mar. 15, 2013, titled PAGE EDITING, and the disclosure of which is incorporated herein by reference.

This application claims the benefit of U.S. Provisional Patent Application Ser. No. 61/708,561, filed Oct. 1, 2012, titled PAGE EDITING, and the disclosure of which is incorporated herein by reference.

This application claims the benefit of U.S. Provisional Patent Application Ser. No. 61/668,962; filed Jul. 6, 2012; titled HIDDEN SYSTEM MENU; and the disclosure of which is incorporated herein by reference.

### BACKGROUND

### Discussion of the Related Art

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Accurate data, including, for example, navigation, mapping, and the location of stationary and moving objects, can be very useful for marine activities. The operator of a marine vessel monitors marine traffic. A device that is easy to operate and that provides data in an easy to follow format can provide advantages to the vessel operator. Such advantages may include requiring less time to request and review information, which in turn provides the vessel operator with more time to monitor the marine traffic.

### SUMMARY

Described herein are various implementations for an apparatus and method for displaying marine electronics data. In one implementation, a non-transitory computer-readable medium has stored thereon computer-executable instructions. When the computer-executable instructions are executed by a computer, the computer-executable instructions cause the computer to present a plurality of possible marine electronics data types to be displayed. The computer-executable instructions also cause the computer to receive two or more selections of the possible plurality of marine electronics data types and provide a plurality of templates for displaying the two or more selections. Each template includes two or more windows corresponding to the two or more selections. The computer-executable instructions are further configured to cause the computer to receive a selection from the plurality of templates and display the two or more selections of the plurality of marine electronics data types in the two or more windows.

Described herein are various implementations of various technologies for a non-transitory computer-readable medium having stored thereon computer-executable instructions. When the computer-executable instructions are executed by the computer, the computer displays two or more windows. The computer-executable instructions also cause the computer to receive a request to resize the two or more windows. The computer-executable instructions cause the computer to display an object disposed at an intersection of the two or more windows. The two or more windows can be resized using the object.

Described herein are also implementations of various technologies for an apparatus for displaying marine electronics data. The apparatus includes one or more processors, a screen and a memory. The memory stores a plurality of executable instructions. When the executable instructions are executed by the one or more processors, the one or more processors present a plurality of possible marine electronics data types to be displayed. The one or more processors receive two or more selections of the possible plurality of marine electronics data types and provide a plurality of templates for displaying the two or more selections. Each template comprises two or more windows corresponding to the two or more selections. The executable instructions are further configured to cause the one or more processors to receive a selection from the plurality of templates and display the two or more selections of the plurality of marine electronics data types in the two or more windows.

Described herein are also implementations of various technologies for a method for display marine electronics data. The method includes presenting, on a screen, a plurality of possible marine electronics data types to be displayed. Two or more selections of the possible plurality of marine electronics data types are received. A plurality of templates for displaying the two or more selections is provided. Each template includes two or more windows corresponding to the two or more selections. A selection from the plurality of templates is received. The two or more windows display the two or more selections of the plurality of marine electronics data.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 is a block diagram of a multi-function display in accordance with implementations described herein.

FIG. 2 illustrates a schematic diagram of the multi-function display displaying a graphical user interface providing a selection of marine electronics data types for display in accordance with implementations described herein.

FIG. 3 illustrates a schematic diagram of a graphical user interface of the multi-function display with an option for customizing the display of marine electronics data types in accordance with implementations described herein.

FIG. 4 is illustrates a schematic diagram of a graphical user interface for customizing display of marine electronics data in accordance with implementations described herein.

FIG. 5 is a schematic diagram illustrating the addition of a marine electronics data type to the customized display of the marine electronics data in accordance with implementations described herein.

FIG. 6 is a schematic diagram illustrating a customized display of marine electronics data after the addition of a marine electronics data type in accordance with implementations described herein.

FIG. 7 is a schematic diagram illustrating the addition of another marine electronics data type to the customized display of marine electronics data in accordance with implementations described herein.

FIG. 8 is a schematic diagram illustrating templates for orienting windows displaying marine electronics data types in accordance with implementations described herein.

FIG. 9 is a schematic diagram illustrating switching marine electronics data types from different windows in accordance with implementations described herein.

FIG. 10 is a schematic diagram illustrating marine electronics data types switched from different windows in accordance with implementations described herein.

FIG. 11 is a schematic diagram illustrating an exemplary layout of resizable windows displaying marine electronics data in accordance with implementations described herein.

FIG. 12 is a schematic diagram illustrating a graphical user interface including an option for requesting an object for resizing windows in accordance with implementations described herein.

FIG. 13 is a schematic diagram illustrating an object for resizing windows in accordance with implementations described herein.

FIG. 14 is a schematic diagram illustrating resizing of windows in accordance with implementations described herein.

FIG. 15 is a schematic diagram illustrating the setting of resized windows in accordance with implementations described herein.

FIG. 16 is a schematic diagram illustrating the resized windows in accordance with implementations described herein.

FIGS. 17A and 17B illustrate a flow diagram for customizing the display of marine electronics data in accordance with implementations described herein.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. Nothing in this application is considered critical or essential to the claimed invention unless explicitly indicated as being “critical” or “essential.”

Reference will now be made in detail to various implementations, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the implementations.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

“Alternatively” shall not be construed to only pertain to situations where the number of choices involved is exactly two, but rather refers to another possibility among many other possibilities.

Additionally, various technologies and techniques described herein include receiving user requests for a number of different operations. In certain instances, the user request for a particular operation will be explicitly described. It shall be understood that “user request” or “user can request” shall also include, but are not limited to, touching the screen, double tapping the screen (tapping the screen twice in rapid succession), pressing a particular physical or virtual button, making a selection from a menu, placement of a cursor at a particular location, stylus pointing, mouse selection, an audible command, as well as the explicit description of the “user request” for the particular operation or how the “user can request”, explicitly, the particular operations.

In one implementation, the user can customize the display of marine electronics data. The multi-function display may be configured to display a number of different types of marine electronics data in different windows. The user can select the particular types of marine electronics data that are displayed in the windows. In certain implementations, the user can also select an orientation of the windows.

Additionally, in certain implementations, the user can swap marine electronics data types from an originating window to a destination window by selecting the contents of the originating window and dragging the marine electronics data type to the destination window.

In certain implementations, the user can also resize the windows. The user can resize the windows by dragging an edge or corner of the window to a particular location. The edge of the window may encompass both edges and corners. Depending on the location, the window will either be enlarged or reduced, horizontally or vertically. In the case of enlarging the window (either vertically or horizontally), the window may occupy additional space on the touch screen. The remaining windows may automatically be reduced in size by the amount of the additional space. In the case of reducing the window size (either vertically or horizontally), the remaining windows may cover the additional space.

Initially, this document will describe the structure of the multi-function display. Then, this document will describe how the different marine electronics data types are selected. This will be followed by a description of how the different marine electronics data are oriented and can be swapped. Finally, this document will describe how the windows can be resized.

### Multi-Function Display

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

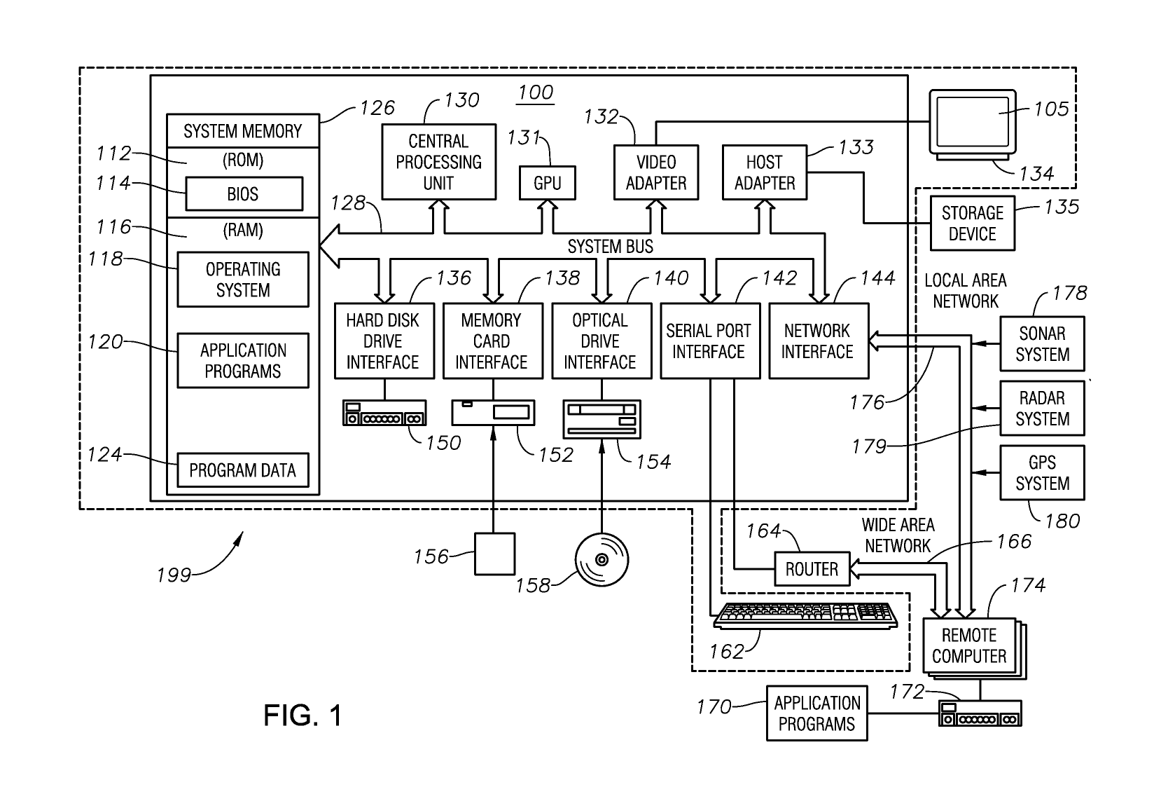

FIG. 1 illustrates a schematic diagram of a multi-function display 199 having a computing system 100 in which the various technologies described herein may be incorporated and practiced. The computing system 100 may be a conventional desktop, a handheld device, personal digital assistant, a server computer, electronic device/instrument, laptop, tablet, or part of a navigation system, marine electronics, or sonar system. It should be noted, however, that other computer system configurations may be used.

The computing system 100 may include a central processing unit (CPU) 130, a system memory 126, a graphics processing unit (GPU) 131 and a system bus 128 that couples various system components including the system memory 126 to the CPU 130. Although only one CPU 130 is illustrated in FIG. 1, it should be understood that in some implementations the computing system 100 may include more than one CPU 130.

The CPU 130 can include a microprocessor, a microcontroller, a processor, a programmable integrated circuit, or a combination thereof. The CPU 130 can comprise an off-the-shelf processor such as a Reduced Instruction Set Computer (RISC™), or a Microprocessor without Interlocked Pipeline Stages (MIPS™) processor, or a combination thereof. The CPU 130 may also include a proprietary processor.

The GPU 131 may be a microprocessor specifically designed to manipulate and implement computer graphics. The CPU 130 may offload work to the GPU 131. The GPU 131 may have its own graphics memory, and/or may have access to a portion of the system memory 126. As with the CPU 130, the GPU 131 may include one or more processing units, and each processing unit may include one or more cores.

The CPU 130 may provide output data to a GPU 131. The GPU 131 may generate graphical user interfaces that present the output data. The GPU 131 may also provide objects, such as menus, in the graphical user interface. A user may provide inputs by interacting with the objects. The GPU 131 may receive the inputs from interaction with the objects and provide the inputs to the CPU 130. A video adapter 132 may be provided to convert graphical data into signals for a monitor 134. The monitor 134 includes a touch screen 105. The touch screen 105 can be sensitive to heat or touching (now collectively referred to as a “touch screen”).

The system bus 128 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 126 may include a read only memory (ROM) 112 and a random access memory (RAM) 116. A basic input/output system (BIOS) 114, containing the basic routines that help transfer information between elements within the computing system 100, such as during start-up, may be stored in the ROM 112.

The computing system 100 may further include a hard disk drive interface 136 for reading from and writing to a hard disk 150, a memory card reader 152 for reading from and writing to a removable memory card 156, and an optical disk drive 154 for reading from and writing to a removable optical disk 158, such as a CD ROM or other optical media. The hard disk 150, the memory card reader 152, and the optical disk drive 154 may be connected to the system bus 128 by a hard disk drive interface 136, a memory card reader interface 138, and an optical drive interface 140, respectively. The drives and their associated computer-readable media may provide nonvolatile storage of computer-readable instructions, data structures, program modules and other data for the computing system 100.

Although the computing system 100 is described herein as having a hard disk, a removable memory card 156 and a removable optical disk 158, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 100 may also include a host adapter 133 that connects to a storage device 135 via a small computer system interface (SCSI) bus, a Fiber Channel bus, an eSATA bus, or using any other applicable computer bus interface. The computing system 100 can also be connected to a router 164 to establish a wide area network (WAN) 166 with one or more remote computers 174. The remote computers 174 can also include hard disks 172 that store application programs 170.

In certain implementations, various techniques, including the flow diagram, described herein can be implemented by a plurality of executable instructions stored in RAM. Alternatively, the plurality of executable instruction can be stored in the hard disk 150, or removable computer-readable media such as memory card 156 or optical media 158 until needed for execution.

A number of program modules may be stored on the hard disk 150, memory card 156, optical disk 158, ROM 112 or RAM 116, including an operating system 118, one or more application programs 120, and program data 124. The application programs 120 may include various mobile applications (“apps”) and other applications configured to perform various methods and techniques described herein. The operating system 118 may be any suitable operating system that may control the operation of a networked personal or server computer.

A user may enter commands and information into the computing system 100 through input devices such as buttons 162. Other input devices may include a microphone (not shown) or through the touch screen 105. These and other input devices may be connected to the CPU 130 through a serial port interface 142 coupled to system bus 128, but may be connected by other interfaces, such as a parallel port, game port or a universal serial bus (USB).

Certain implementations may be configured to be connected to a sonar system 178, radar interface 179, and GPS system 180. The sonar system 178, radar interface 179, and GPS system 180 may be connected via the network interface 144. The computing system 100, the monitor 134, the touch screen 105, and the buttons 162 may be integrated into a console, forming the multi-function display 199.

### Selection of Different Marine Electronics Data Types

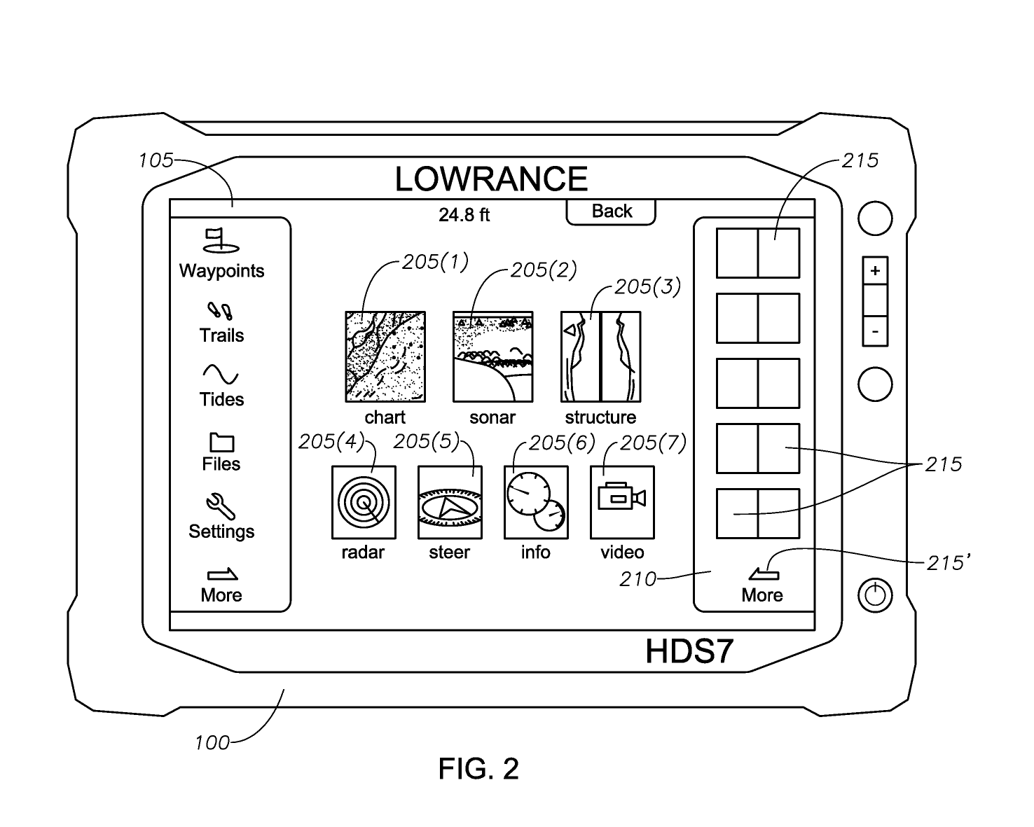

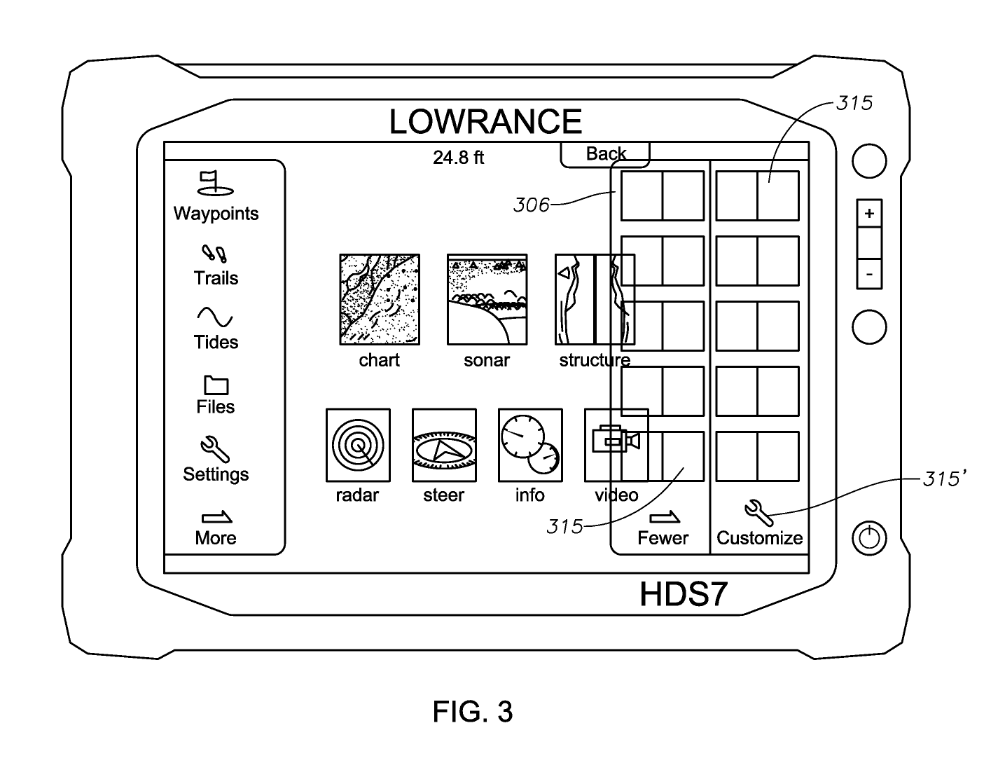

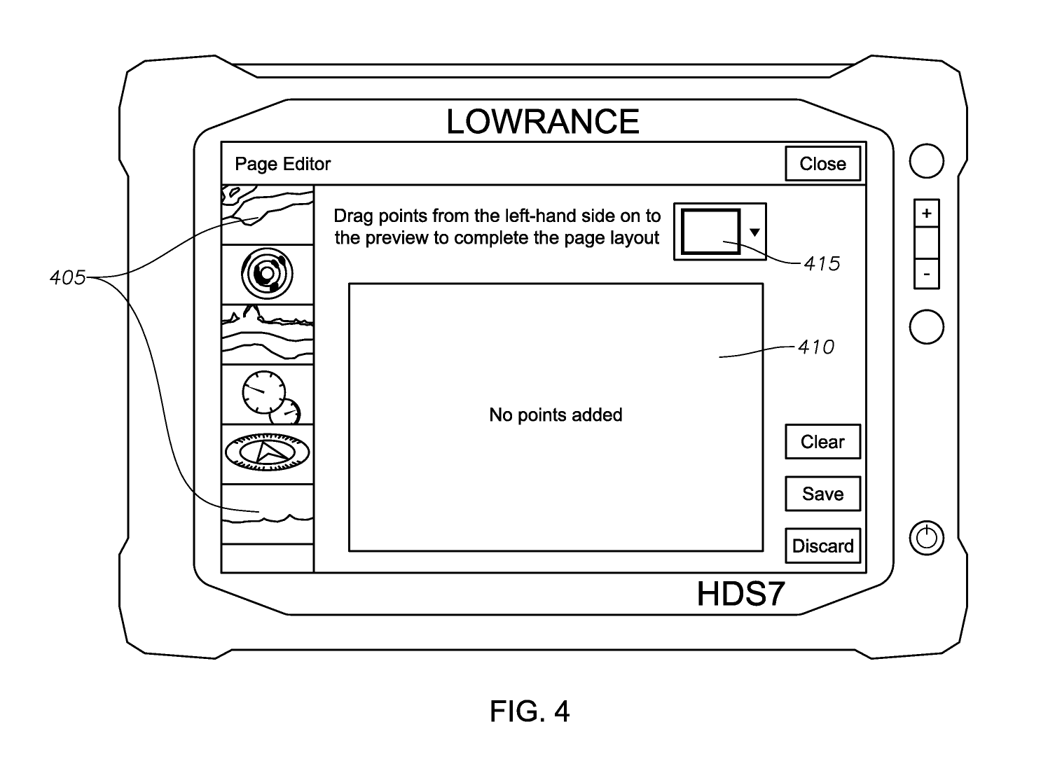

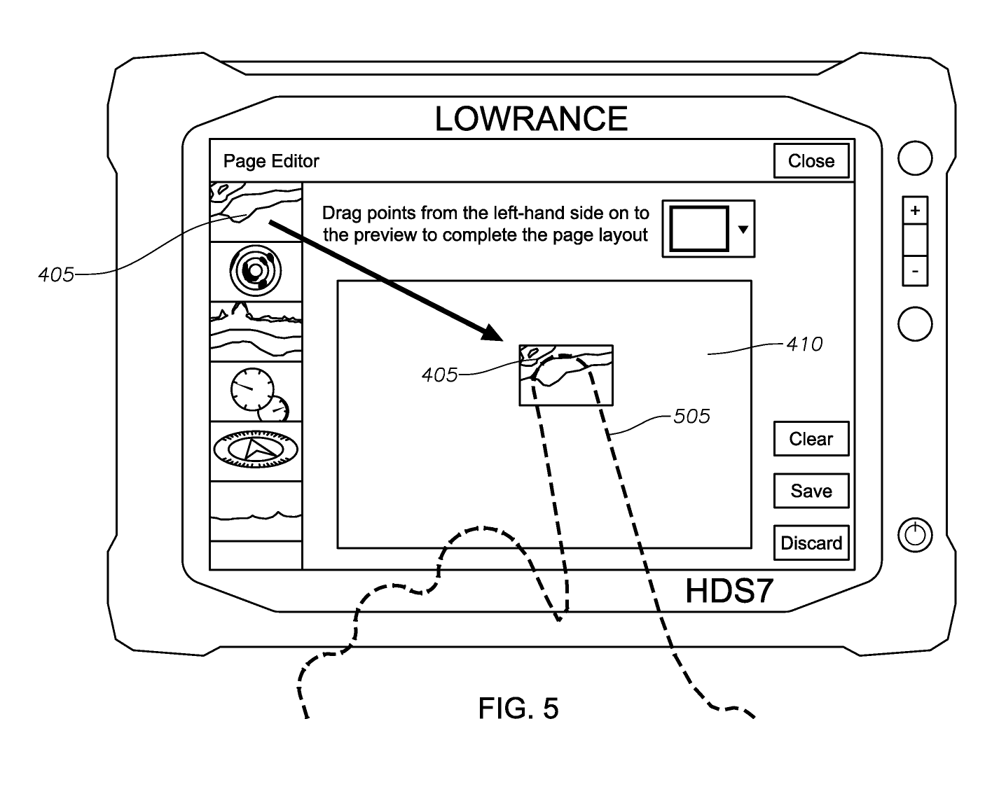

The multi-function display 199 can display marine electronics data on the touch screen 105. The display of the marine electronics data can be customized to include particular types of marine electronics data. FIGS. 2 and 3 show the types of marine electronics data that can be displayed and how to select an option for customizing the display. FIG. 4 illustrates a graphical user interface for customizing the display. FIGS. 5-7 illustrate dragging icons representing different types of marine electronics data to a palette.

FIG. 2 illustrates a schematic diagram of a graphical user interface of the multi-function display. The graphical user interface provides a selection of marine electronics data types for display in accordance with implementations described herein. The different marine electronics data types are presented by icons 205. The icons may include an icon for chart data type 205(1), sonar data type 205(2), structure data type 205(3), radar data type 205(4), steering data type 205(5), dashboard information type 205(6), and video 205(7).

The chart data type icon 205(1) may be configured for displaying a local map of a region surrounding the location of the display device 100. Where the display device 100 is carried over a body of water by a vessel, the sonar data type icon 205(2) may be configured for displaying sonar data from the body of water surrounding the vessel. The structure data type icon 205(3) may be configured for providing a higher resolution image covering a wider area of the body of water surrounding the vessel. The radar data type icon 205(4) may be configured for providing a radar view of the area surrounding the display device 100. The steering data type icon 205(5) may be configured for displaying information, such as distance to destination, speed over ground, and time to destination. The dashboard data type icon 205(6) may be configured for displaying an instrument panel for a vessel carrying the display device. The instrument panel may include measurement meters that provide information such as, for example, bearing, speed, fuel level, and oil level.

Additionally, the touch screen 105 displays a side tray 210 of additional options 215. Among the additional options 215 is an option 215′ for more additional options. Selection of option 215′ may bring out another tray menu that includes an option for customizing the display.

FIG. 3 illustrates a schematic diagram of the tray menu 306 in accordance with implementations of various techniques described herein. The tray menu 306 may include one or more hidden tray options 315. The options 315 are previously saved customized displays of marine electronics data. The manner of saving the customized displays will be explained later in the document.

The tray menu 306 may also include an option 315′ for creating a new customized display. Selection of option 315′ invokes a graphical user interface for creating and saving the new customized display.

FIG. 4 illustrates a schematic diagram of a graphical user interface for customizing display of marine electronics data in accordance with implementations described herein. The graphical user interface may display icons 405 representing different types of marine electronics data, a palette 410 for creating a customized display of marine electronics data, and an orientation menu 415 for orienting windows that display the marine electronics data.

A user can create a customized display of marine electronics data by selecting desired types of marine electronics data from the icons 405 and dragging the icons 405 to the palette 410. If the number of icons 405 that are dragged to the palette 410 is two or more, the different marine electronics data types are displayed in different windows. The user can orient the different windows by selecting the orientation menu 415.

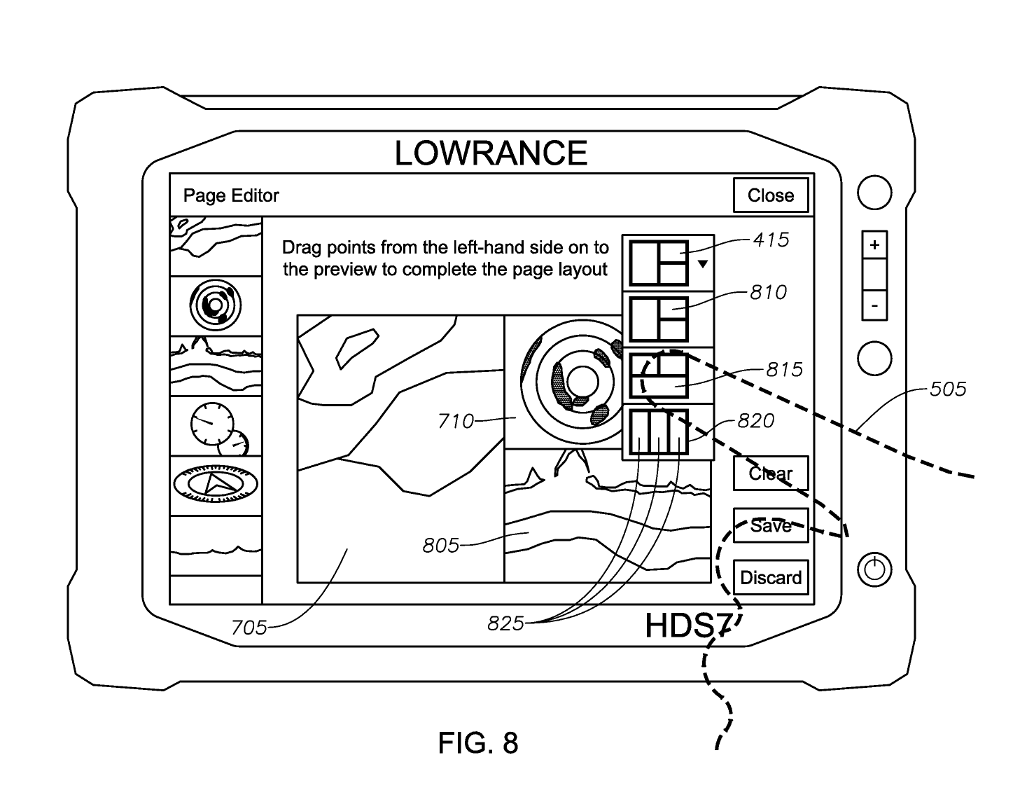

FIG. 5-7 describe dragging the icons 405 to the palette 410. FIG. 8 describes selecting the orientation of the windows from the orientation menu 415. FIG. 5 illustrates the addition of a marine electronics data type to the customized display of marine electronics data in accordance with implementations described herein. The user can select a desired marine electronics data type by selecting the icon 405 associated with the desired marine electronics data type and dragging the icon 405 to the palette 410 and releasing the icon 405. In certain implementations, the user can select and drag the icon 405 to the palette 410 by touching the icon 405 with their finger 505 and swiping the icon 405 to the palette 410.

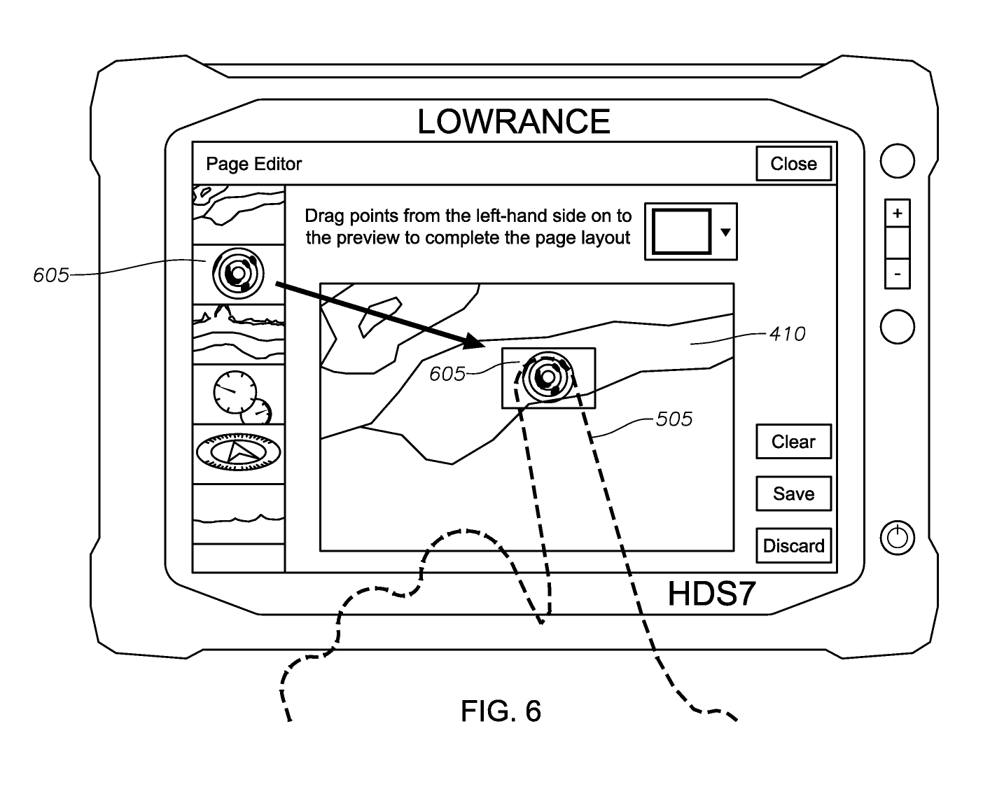

After selecting and dragging the icon 405 to the palette 410, the palette displays the associated marine electronics data type. If only one icon 405 has been dragged to the palette, the marine electronics data type associated with the icon 405 consumes the entire area of the palette 410. FIG. 6 is a schematic diagram illustrating a resulting palette 410 after the addition of a marine electronics data type in accordance with implementations described herein. As noted above, since only a single icon 405 was dragged to the palette 410, the marine electronics data associated with the icon 405 consumes the entire palette 410.

The user can select an additional marine electronics data type to add to the palette 410 by selecting another icon 605 associated with the desired additional marine electronics data type and dragging the icon 605 over the palette 410. Similar to icon 405, the user can select and drag the additional icon 605 to the palette 410 by touching the icon 605 with their finger 505 and swiping the icon 605 to the palette 410.

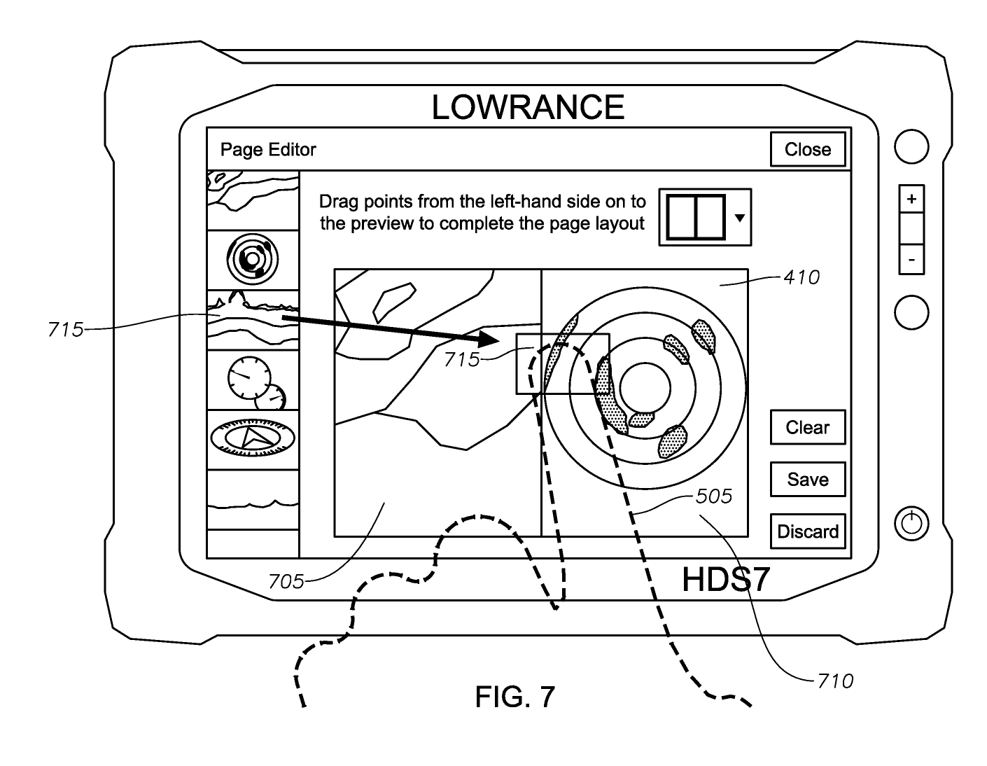

In response to dragging icons 405 and 605 to the palette 410, the palette 410 will display marine electronics data associated with each icon 405, 605 in separate windows. FIG. 7 is a schematic diagram illustrating the addition of another marine electronics data type to the customized display of marine electronics data in accordance with implementations described herein. The palette 410 includes a separate window 705, 710 for each of the marine electronics data types associated with icons 405, 605. In certain implementations, the template menu 415 for orienting the windows 705, 710 can be updated for the number of icons selected 405, 605. In the case of two selected icons, e.g., icons 405, 605, the template menu 415 can have templates for side-by-side orientation (shown), or top/bottom (not shown).

The user can continue to select additional icons, e.g., icon 715, by dragging and swiping the icon 715 to the palette 410. In response, the palette 410 will automatically create another window for the marine electronics data type associated with the icon 715. In certain implementations, the multi-function display 199 may automatically update the template menu 415 to include templates with the new number of marine electronics data types that are selected.

### Orientation of the Customized Display

FIG. 8 is a schematic diagram illustrating templates for orienting windows for displaying marine electronics data types in accordance with implementations described herein. The palette 410 includes three windows 705, 710, and 805 for the three selected marine electronics data types. Since the palette 410 accommodates another window 805 (from FIG. 7), at least one of the previously existing windows 710 is modified to make room for the new window 805.

In certain implementations, the multi-function display 199 can update the template menu 415 to provide templates 810, 815, 820 for the possible representations of windows 825, e.g., three. The multi-screen display 199 may highlight the template 810 corresponding to the present orientation of the windows 705, 710, and 805. However, the user can change the orientation by selecting another one of the templates 810, 815, 820. Although certain exemplary templates, 810, 815, 820, are shown, the exemplary templates 810, 815, 820 are not intended to be an exhaustive set of templates.

For example, the user can select an orientation wherein the one of the windows 705, 710, 805 occupy the bottom half of the palette 410, while the remaining two windows of the windows 705, 710, 805 horizontally split the top half of the palette 410 by selecting template 810. In certain implementations, the user can select template 810 by physically touching template 810 with their finger 505.

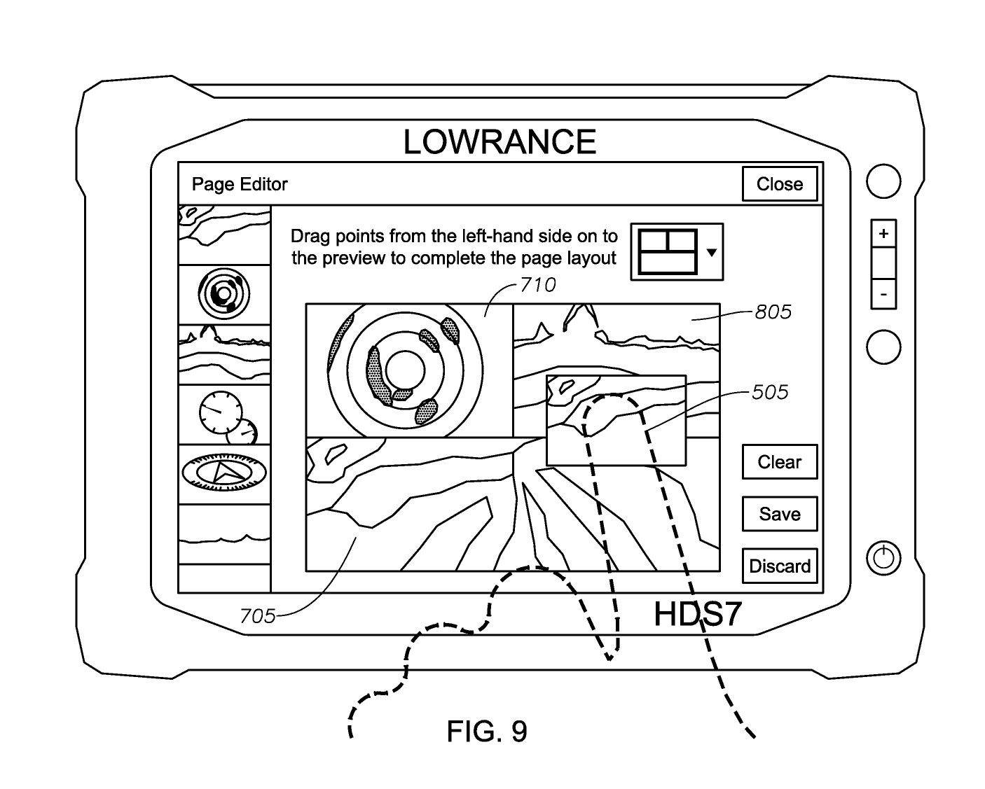

FIG. 9 is a schematic diagram illustrating the resulting palette 410 in accordance with the selected template 810. Window 705 occupies the bottom half of the palette 410, while windows 710 and 805 split the top half of the palette 410. In certain implementations, the user can switch the marine electronics data types that are displayed in each window 705, 710, 805. The user can switch the marine electronics data types that are displayed by selecting the marine electronics data type in the originating window, dragging it to the destination window, and releasing it.

In certain implementations, the user can move the marine electronics data type displayed in originating window 705 by touching it with their finger 505 and swiping it to the destination window 805. The multi-function display 199 will then switch the marine electronics data types that are displayed in windows 705 and 805 with each other.

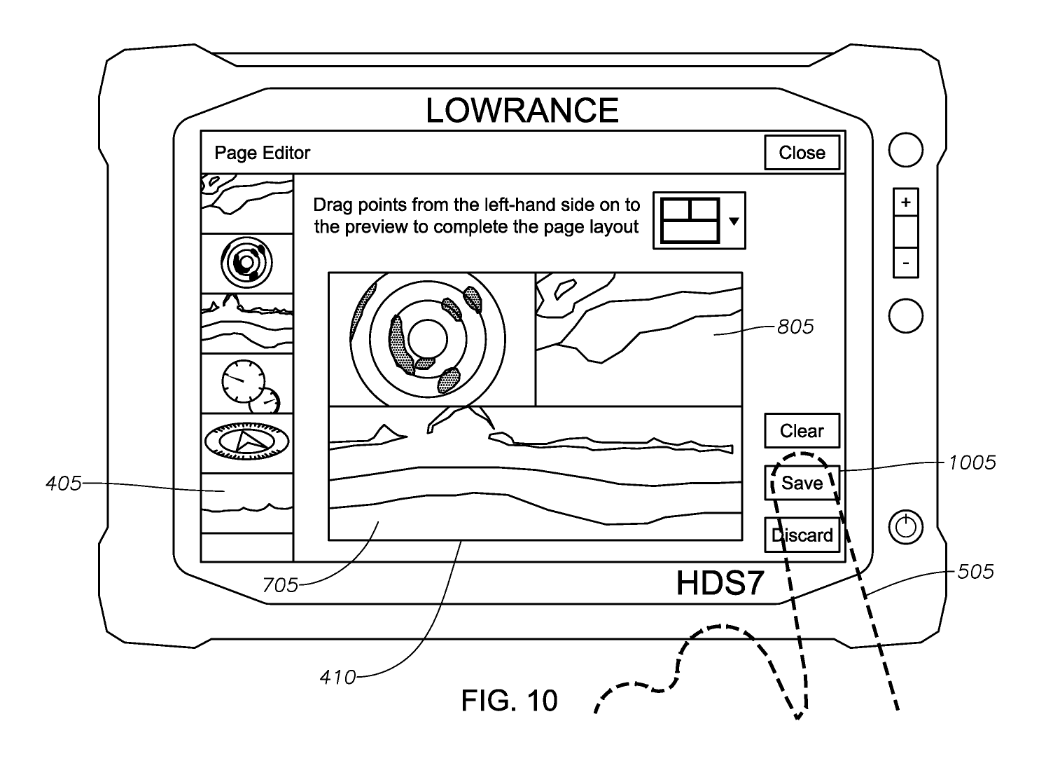

FIG. 10 is a schematic diagram illustrating marine electronics data types switched from different windows in accordance with implementations described herein. The marine electronics data that was previously displayed in window 705 is now displayed in window 805, and vice versa. If the user is satisfied with the representation of the presentation of the marine electronics data in the palette 410, the user can choose to save it by selecting a save button 1005.

It is noted that although three windows are shown, in certain implementations, more than three windows can be shown. For example, in certain implementations, selecting and dragging additional icons, e.g., icon 405, causes creation of additional windows in the palette 410 and a new template menu 415 with templates reflecting the new number of selected marine electronics data types.

Selecting the save button 1005 causes the palette 410 to occupy the touch screen 105. In certain implementations, the user can select the save button 1005 by touching it with their finger 505. Additionally, turning to FIG. 3, in certain implementations selection of the save button 1005 creates an icon 315 that resembles the palette 410 in the tray menu 306. The user can then use the icon 315 as a shortcut for re-customizing the same selection and orientation of the marine electronics data.

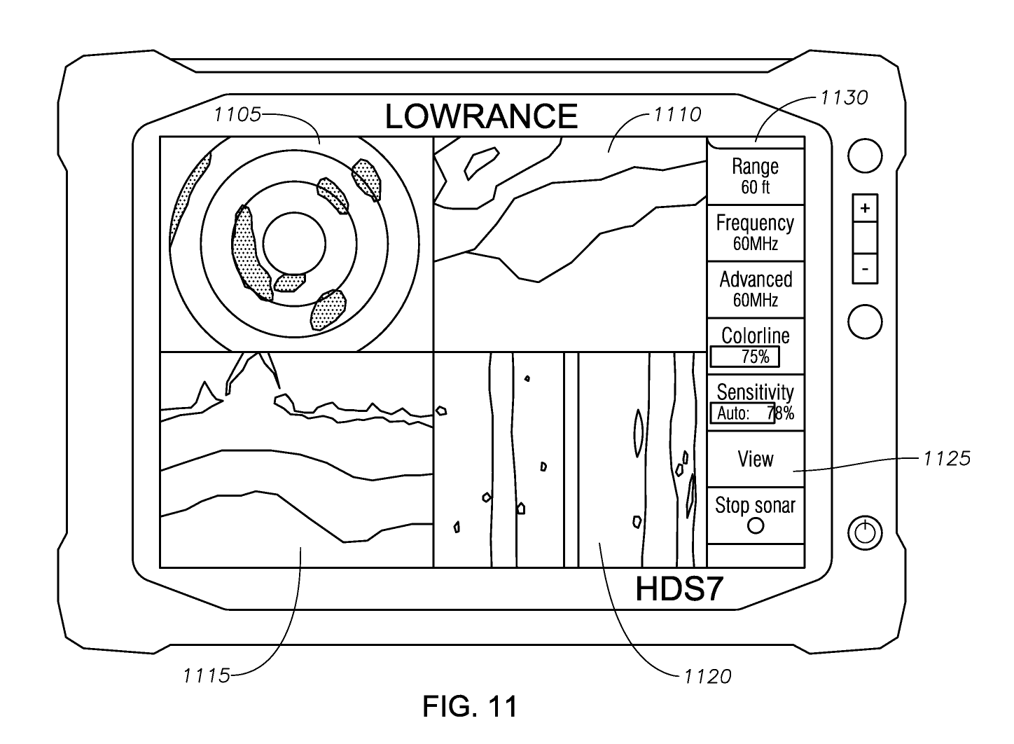

After the types of the marine electronics data are selected and oriented for display on the touch screen 105 of the multi-function display 199, the user can further customize the display by resizing the windows. FIGS. 11-17 will describe resizing the windows.

### Resizing the Windows

FIG. 11 illustrates an exemplary layout of resizable windows in accordance with implementations described herein. In the present example, the user has selected radar data for display in window 1105, chart data in window 1110, sonar data in window 1115, and sonar structure data in window 1120. The touch screen 105 also displays a side data tray 1125 that includes various settings such as range, frequency, color line, and sensitivity. Additionally, the side data tray 1125 includes a notch 1130 for selecting a new menu. In certain implementations, the user can select the notch 1130 by touching it.

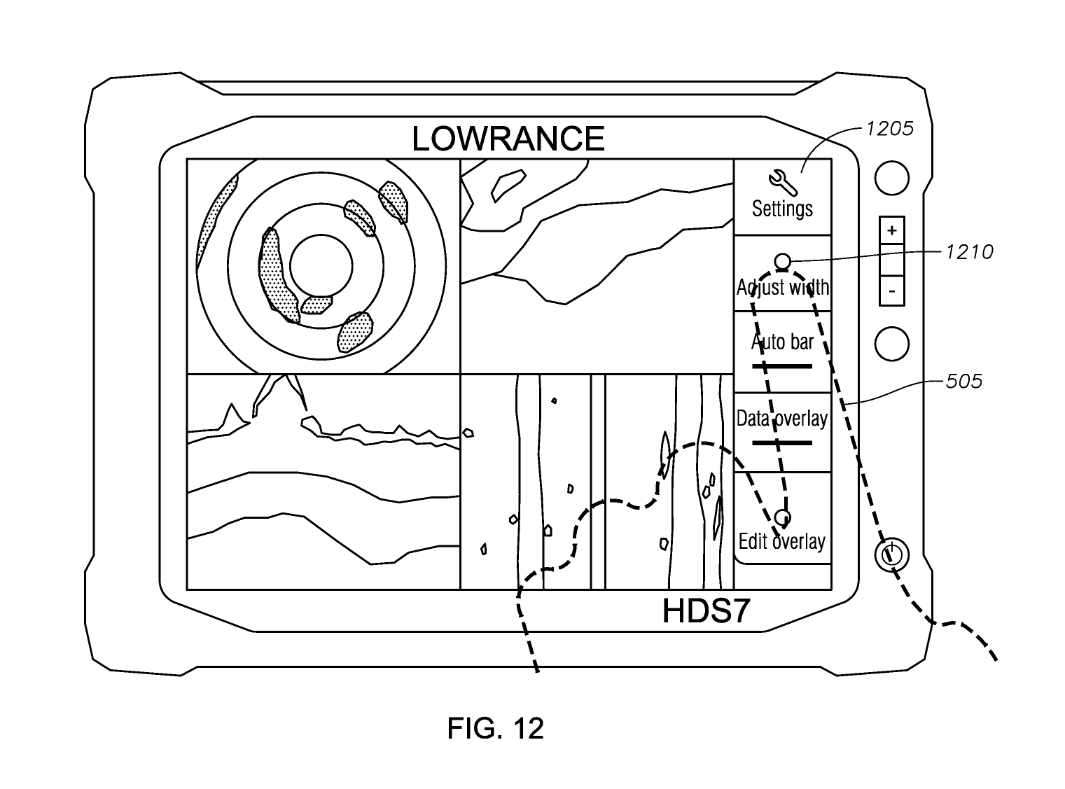

FIG. 12 is illustrates invoking an object for resizing windows in accordance with implementations described herein. As noted above, the selection of the notch 1130 results in the display of a new menu 1205. The new menu 1205 includes an option 1210 for adjusting the width of the windows 1105, 1110, 1115, and 1120. Selection of option 1210 may result in the display of a directional sliding button at the intersection of the windows 1105, 1110, 1115, and 1120.

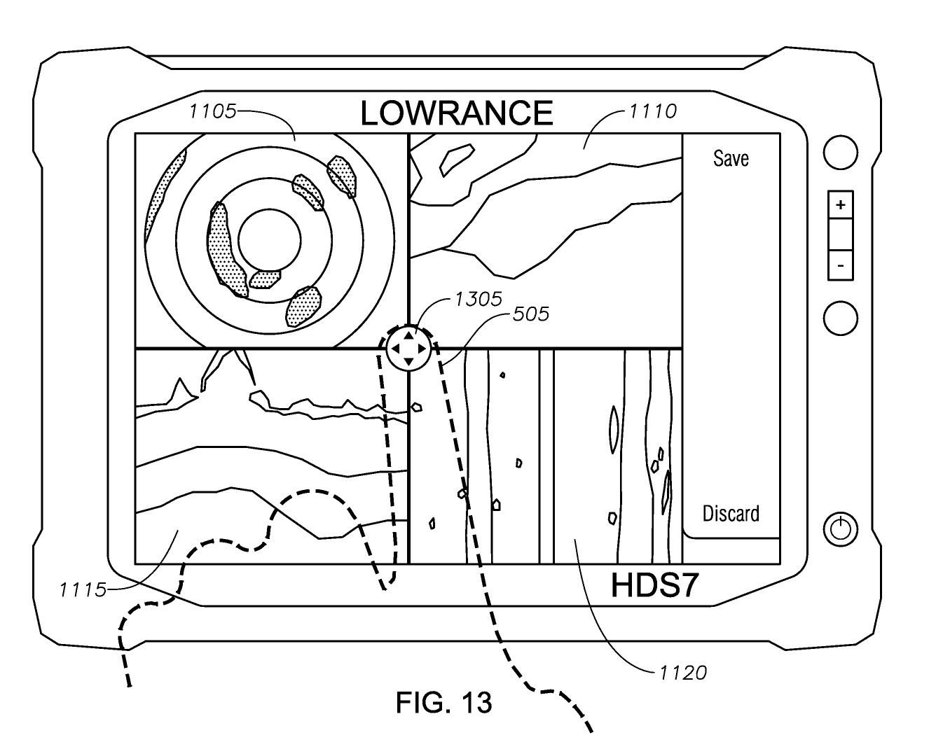

FIG. 13 is a schematic illustrating a directional sliding button 1305 in accordance with implementations described herein. The sliding button 1305 appears at the intersection of each of the displayed windows 1105, 1110, 1115, and 1120. Moving the sliding button 1305 can result in vertical enlargement, vertical shrinking, horizontal enlargement and horizontal shrinking of some of the windows 1105, 1110, 1115, and 1120. In certain implementations, the corners of each of the windows 1105, 1110, 1115, and 1120 are fixed at the sliding button 1305. Movement of the sliding button 1305 to another location results in movement of the corners of the windows to the new location of the sliding button 1305. In certain implementations, the user can move the sliding button 1305 by touching it with their finger 1305 and swiping the slider button 1305 to the new location.

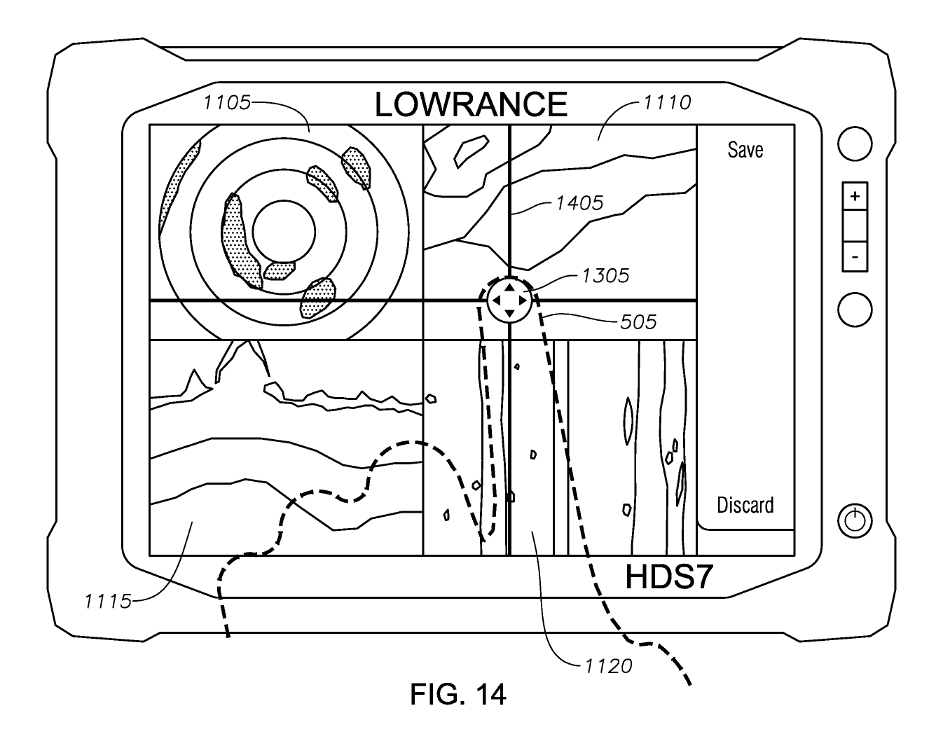

FIG. 14 is a schematic diagram illustrating resizing windows in accordance with implementations described herein. The user is shown as swiping the sliding button 1305 with their finger 505. In certain implementations, while the user is swiping the sliding button 1305, the touch screen 105 displays a guiding grid 1405. The guiding grid 1405 indicates the contours of the windows 1105, 1110, 1115, and 1120 that will result if the sliding button 1305 is set at its current location.

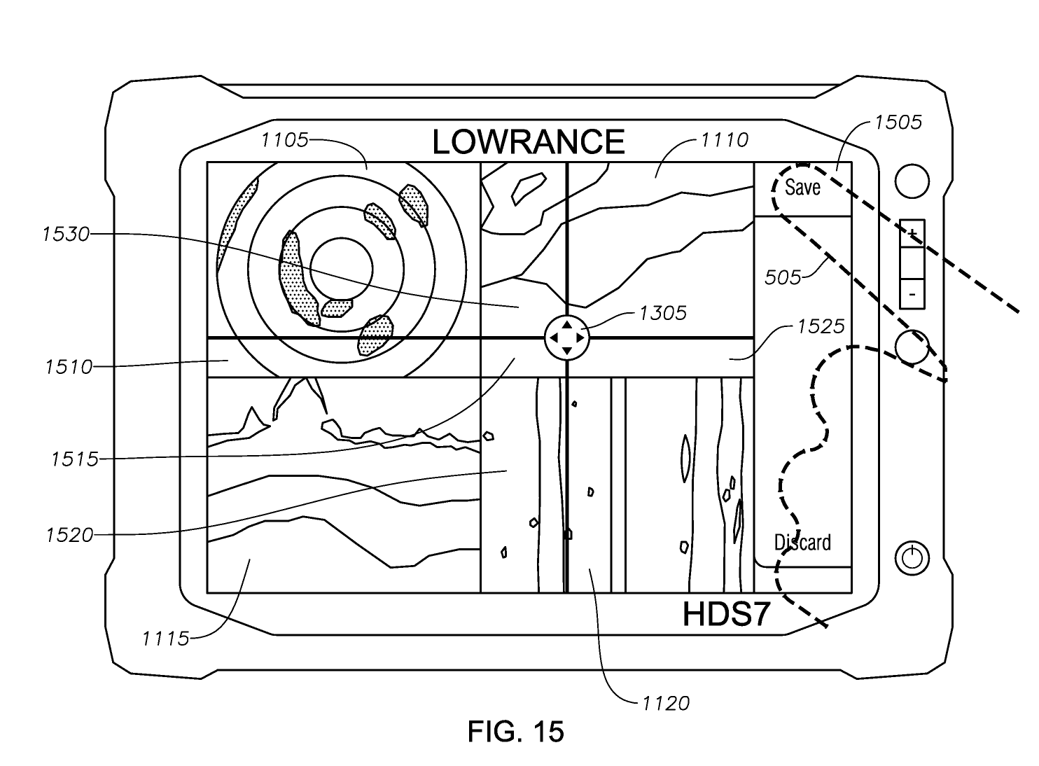

FIG. 15 illustrates saving/setting the resized windows in accordance with implementations described herein. By moving the sliding button 1305, window 1105 will be vertically shrunk, and horizontally enlarged, window 1110 will be shrunk, vertically and horizontally, window 1115 will be enlarged, vertically and horizontally, and window 1120 will be enlarged horizontally, but shrunk vertically. Window 1115 will consume additional space 1510 from window 1105, window 1110 and window 1120. Window 1110 will provide additional space 1530 to window 1105, additional space 1510 to window 1115, and additional space 1525 to window 1120. Window 1105 will provide additional space 1510 to window 1115 and consume additional space 1530 from window 1110. Window 1120 will provide additional space 1520 to window 1115, and consume additional space 1525 from window 1110.

After the user swipes the sliding button 1305, the screen displays an option 1505 to save/set the size of the windows 1105, 1110, 1115, and 1120 in accordance with guiding gridlines 1405. In certain implementations, the user can select the option 1505 by touching it with their finger 505.

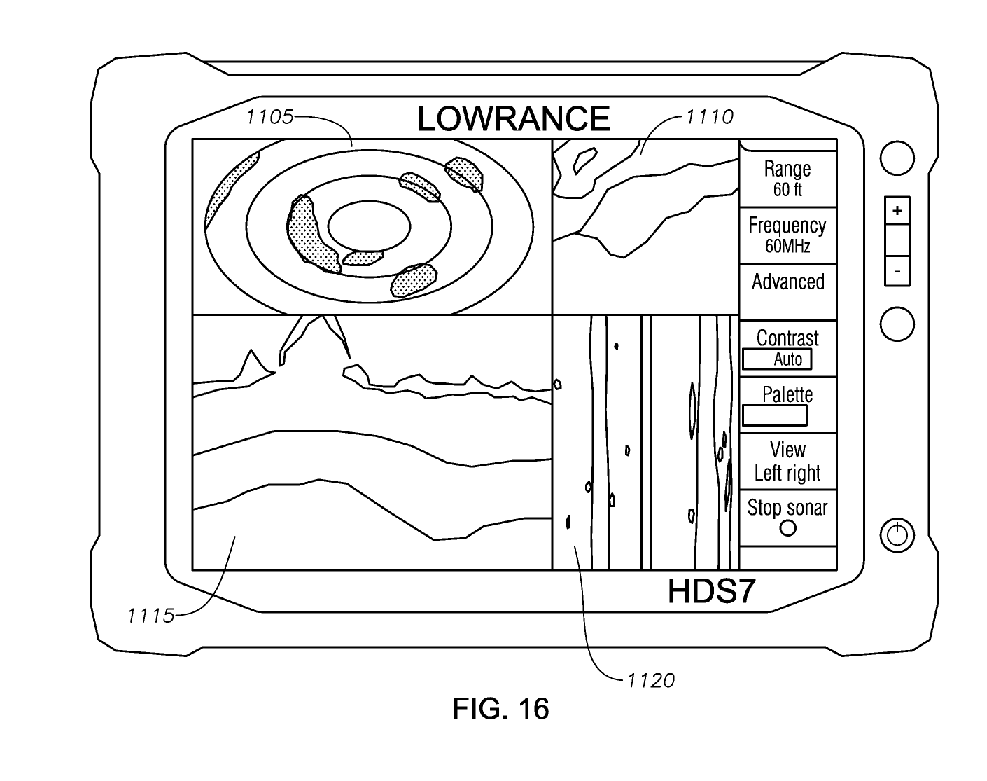

FIG. 16 is a schematic diagram illustrating the resized windows in accordance with implementations described herein. As a result of the resizing, each window 1105, 1110, 1115, and 1120 are set as indicated by the guiding gridlines 1405.

### Flow Diagram

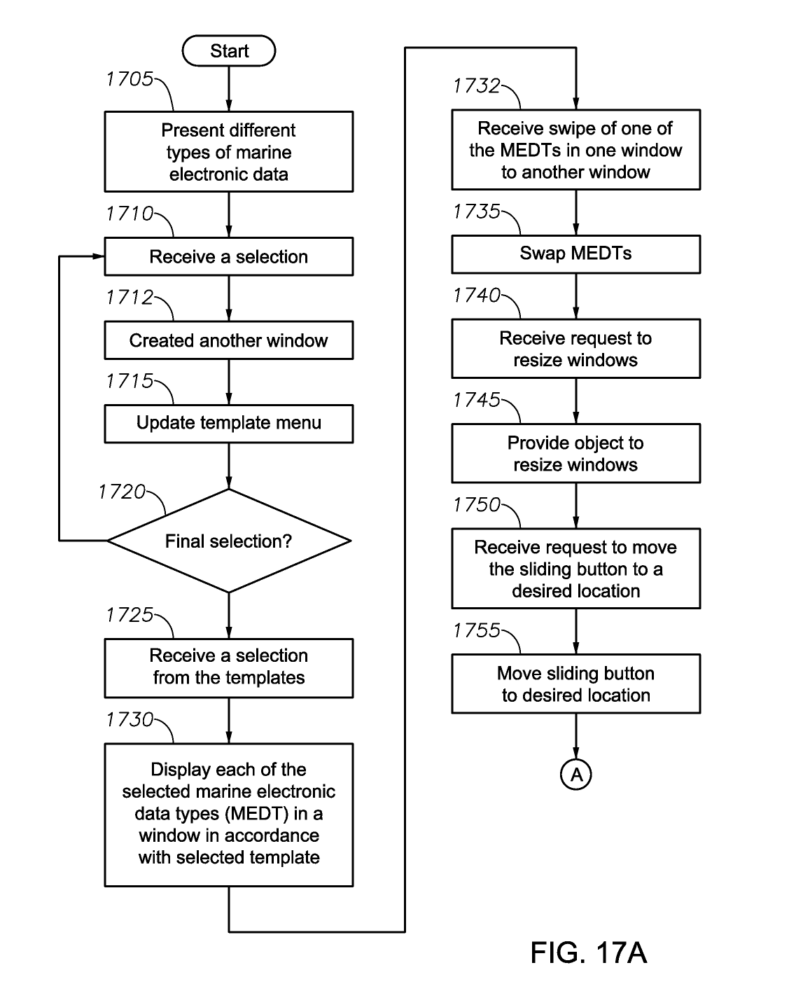

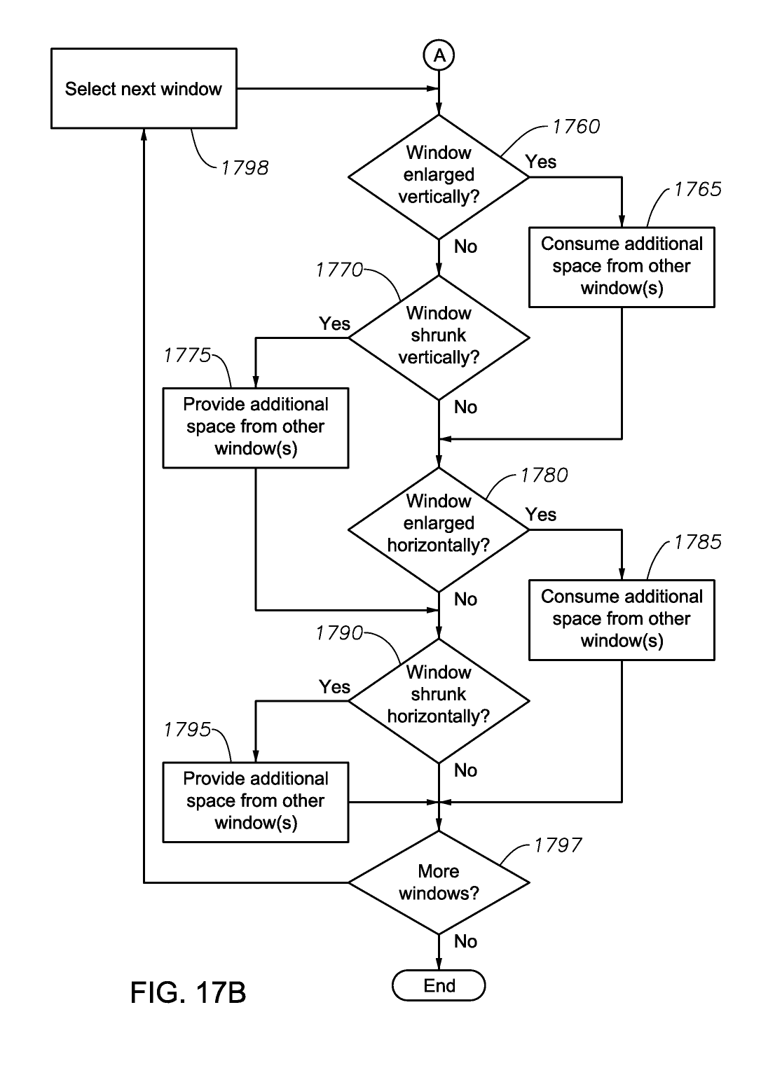

FIG. 17 illustrates a flow diagram for customizing the display of marine electronics data. It should be understood that while the operational flow diagram of FIG. 17 indicates a particular order of execution of the operations, in other implementations, the operations might be executed in a different order. Further, in some implementations, additional operations or steps may be added to the method. Likewise, some operations or steps may be omitted. In certain implementations, the flow diagram of FIG. 17 can be implemented as a plurality of computer-executable instructions stored in a memory, such as the various memory types shown in FIG. 1.

At block 1705, the multi-function display presents different types of marine electronics data. For example, turning to FIG. 4, the multi-function display presents icons 405. At block 1710, the multi-function display 199 receives a selection of a marine electronics data type. For example, turning to FIGS. 5-7, icons 405, 505, and 715 are selected. If the number of selected marine electronics data types is incremented at block 1710, the multi-function display 199 creates another window at block 1712, and updates a template menu to provide templates for the incremented number at block 1715. For example, in FIGS. 7 and 8, selection of the icons 505 and 715 result in creation of an additional window in palette 415. In FIG. 8, the template menu 415 is updated from FIG. 7. In FIG. 7, the template menu 415 has templates with representations of two windows. In FIG. 8, the template menu is updated to present templates 810, 815, and 820 to reflect the third marine electronics data type selection. The templates, e.g., template 820, include representations of three windows 825.

Blocks 1710-1715 are repeated for as many marine electronics data types as are selected (block 1720). At block 1725, the multi-function display 199 receives a selection from the templates. For example, turning to FIG. 8, the user selects template 815.

At block 1730, the multi-function display 199 displays each of the selected marine electronics data types in the windows corresponding to the selected template. For example, turning to FIG. 9, the palette 415 displays the windows oriented according to the template selected in FIG. 8.

At block 1732, the multi-function display 199 detects swiping of one of the marine electronics data types in one of the windows to another window. For example, turning to FIG. 9, the multi-function display 199 detects swiping marine electronics data type 705 over to marine electronics data type 505.

At block 1735, the multi-function display 199 swaps the marine electronics data types in the originating window to the destination window. For example, turning to FIG. 10, the multi-function display 199 swaps marine electronics data type 705 with marine electronics data type 805.

At block 1740, the multi-function display 199 receives a request to resize the windows. For example, turning to FIG. 12, the multi-function display 199 receives a selection of option 1210.

At block 1745, the multi-function display 199 provides an object for resizing the windows. For example, turning to FIG. 13, the multi-function display 199 provides object 1305, e.g., sliding button, for resizing the windows. The sliding button 1305 appears at an intersection of the displayed windows. At block 1750, the multi-function display 199 receives a request to move the sliding button 1305 to a desired location. At block 1755, the multi-function display 199 moves the sliding button 1305 to the desired location. The movement of the sliding button 1305 is illustrated in FIG. 14-15.

Moving to FIG. 17B, for each window, determinations are made if the window is enlarged or shrunk, vertically or horizontally (blocks 1760, 1770, 1780, 1790).

If the window is enlarged vertically, the window consumes additional space from at least another one of the windows (block 1765). If the window is shrunk vertically, the window provides additional space to at least another one of the windows (block 1775). If the window is enlarged horizontally, the window consumes additional space from at least another one of the windows (block 1785). If the window is shrunk horizontally, the window provides additional space to at least another one of the windows (block 1795).

For example, turning to FIG. 15, upon setting/saving the sliding button 1305, window 1105 will be vertically narrower, and horizontally wider, window 1110 will be narrower, vertically and horizontally, window 1115 will be wider, vertically and horizontally, and window 1120 will be wider horizontally, but narrower vertically.

Window 1115 will be enlarged both vertically and horizontally, consuming additional space 1510 from window 1105, additional space 1515 from window 1110, and additional space 1520 from window 1120. Window 1110 will be shrunk both vertically and horizontally, providing additional space 1530 to window 1105, additional space 1510 to window 1115, and additional space 1525 to window 1120. Window 1105 provides additional space 1510 to window 1115 and consumes additional space 1530 from window 1110. Window 1120 provides additional space 1520 to window 1115, and consuming additional space 1525 from window 1110.

Blocks 1760-1798 are repeated for each window until there are no more windows to resize at 1797.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While the foregoing is directed to implementations of various technologies described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A non-transitory computer-readable medium having stored thereon computer-executable instructions which, when executed by a computer, cause the computer to:
present a plurality of possible marine electronics data types to be displayed;
receive two or more selections of the possible plurality of marine electronics data types;
provide a plurality of templates for displaying the two or more selections, wherein each template comprises two or more windows corresponding to the two or more selections;
receive a selection from the plurality of templates; and
display the two or more selections of the plurality of marine electronics data types in the two or more windows.

2. The non-transitory computer-readable medium of claim 1, further comprising computer-executable instructions that cause the computer to:
receive additional selections of the plurality of possible marine electronics data types;
update the two or more windows in each template to correspond to the additional selections.

3. The non-transitory computer-readable medium of claim 1, further comprising computer-executable instructions that cause the computer to switch one of the two or more selections displayed in a first window with another one of the two or more selections displayed in a second window.

4. The non-transitory computer-readable medium of claim 3, wherein the computer-executable instructions that cause the computer to switch comprise computer-executable instructions that cause the computer to:
receive a selection of the one of the two or more selections; and
receive a request to drag the one of the two or more selections to the second window.

5. The non-transitory computer-readable medium of claim 1, further comprising computer-executable instructions that cause the computer to:
receive a request to resize the two or more windows;
display an object disposed at an intersection of the two or more windows; and
resize the two or more windows using the object.

6. The non-transitory computer-readable medium of claim 5, wherein the computer-executable instructions that cause the computer to resize comprise computer-executable instructions that cause the computer to:
move the object to a desired position, thereby enlarging at least one window and shrinking at least one remaining window in the two or more windows.

7. The non-transitory computer-readable medium of claim 5, wherein the object comprises a sliding button.

8. A non-transitory computer-readable medium having stored thereon computer-executable instructions which, when executed by a computer, cause the computer to:
display two or more windows;
receive a request to resize the two or more windows;
display an object disposed at an intersection of the two or more windows; and
resize the two or more windows using the object.

9. The non-transitory computer-readable medium of claim 8, wherein the computer-executable instructions that cause the computer to resize comprise computer-executable instructions that cause the computer to:
move the object to a desired position, thereby enlarging at least one window and shrinking at least one remaining window in the two or more windows.

10. The non-transitory computer-readable medium of claim 8, further comprising computer-executable instructions which, when executed by a computer, cause the computer to display marine electronics data in the two or more windows.

11. An apparatus comprising:
one or more processors;
a screen; and
a memory storing a plurality of executable instructions which, when executed by the one or more processors, cause the one or more processors to:
present a plurality of possible marine electronics data types to be displayed;
receive two or more selections of the possible plurality of marine electronics data types;
provide a plurality of templates for displaying the two or more selections, wherein each template comprises two or more windows corresponding to the two or more selections;
receive a selection from the plurality of templates; and
display the two or more selections of the plurality of marine electronics data types in the two or more windows.

12. The apparatus of claim 11, wherein the plurality of executable instructions further cause the one or more processors to:
receive additional selections of the said plurality of possible marine electronics data types;
update the two or more windows in each template to correspond to the additional selections.

13. The apparatus of claim 11, wherein the plurality of executable instructions further cause the one or more processors to:
switch one of the two or more selections displayed in a first window with another one of the two or more selections displayed in a second window.

14. The apparatus of claim 13, wherein the plurality of executable instructions that cause the one or more processors to switch further comprises a plurality of executable instructions that cause the one or more processors to:
receive a selection of the one of the two or more selections; and
receive a request to drag the one of the two or more selections to the second window.

15. The apparatus of claim 11, wherein the plurality of executable instructions further cause the one or more processors to:
receive a request to resize the two or more windows;
display an object disposed at an intersection of the two or more windows; and
resize the two or more windows using the object.

16. The apparatus of claim 15, wherein the plurality of executable instructions that cause the computer to resize comprise executable instructions that cause the one or more processors to:
move the object to a desired position, thereby enlarging at least one window and shrinking at least one remaining window in the two or more windows.

17. A method for displaying marine electronics data, said method comprising:
presenting, on a screen, a plurality of possible marine electronics data types to be displayed;
receiving two or more selections of the possible plurality of marine electronics data types;
providing a plurality of templates for displaying the two or more selections, wherein each template comprises two or more windows corresponding to the two or more selections;
receiving a selection from the plurality of templates; and
displaying the two or more selections of the plurality of marine electronics data types in the two or more windows.

18. The method of claim 17, further comprising:
receiving additional selections plurality of possible marine electronics data types;
update the number of windows in each template to correspond to the additional selections.

19. The method of claim 17, further comprising:
switching one of the two or more selections displayed in a first window with another one of the two or more selections displayed in a second window.

20. The method of claim 19, wherein switching further comprises:
receiving a selection of the one of the two or more selections; and
receiving a request to drag the one of the two or more selections to the second window.
